(19) United States
(12) Patent Application Publication
(10) Pub. No.: US 2017/0196069 A1
(43) Pub. Date: Jul. 6, 2017

(54) Combination of Led Lamp and Wireless mesh Environmental Sensors Network

(71) Applicants: NISSIM ZUR, GIVATAIM (IL); ELIAHU ARAD, TZOFIT (IL)

(72) Inventors: NISSIM ZUR, GIVATAIM (IL); ELIAHU ARAD, TZOFIT (IL)

(21) Appl. No.: 15/229,118

(22) Filed: Aug. 5, 2016

Related U.S. Application Data
(60) Provisional application No. 62/201,193, filed on Aug. 5, 2015.

(51) Int. Cl. H05B 37/02; H05B 33/08; H04W 4/00

(52) U.S. Cl. CPC H05B 37/0272; H04W 4/005; H05B 33/0842; H05B 37/0227; H04W 84/18

(57) ABSTRACT

A wireless led lamp is a combination of led lamp and wireless mesh environmental sensors network, and a related Method for creating a Local Sensors Mesh Network. The device and method includes a combination of Led Lamp lighting and wireless mesh network sensors node. The combination of Led Lamp+Sensors assembly is available both as original equipment, and as a retrofit kit for legacy environmental Sensors. The Led Lamp portion of the combination of Led Lamp+Sensors provides area of lighting through a lens located in the housing within which the combination Led Lamp+Sensors is housed. The node portion of the assembly provides sophisticated sensors wireless mesh network functionality such that the placement of a series of devices of the present invention should provide a high quality, Wireless mesh “mesh” environmental habitat or public sensors network. The Led Lamp+Sensors assembly may optionally provide local security/safety functionality, including environmental sensors in order to enable typical safe and “green” habitat environment functionality.

This application claims priority from provisional patent application Ser. No. 62/201193 filing date Aug. 5 2015 which is incorporated herein by reference.

### BACKGROUND OF THE INVENTION

1. Field of the Invention

This invention relates generally to Wireless mesh Environmental Sensors Network systems and, more specifically, to a Combination of Led Lamp and Wireless mesh Sensors Network.

2. Description of Related Art

A Wireless mesh Environmental home Sensors Network of spatially distributed autonomous sensors to monitor physical or environmental conditions, such as temperature, smoke, fire, gas, sound pressure, etc. and to cooperatively pass these sensors data through the network to be of a one main location. The modern networks are bi-directional, also enabling control of sensors activity. The development of Wireless mesh sensors networks was motivated by military applications such as battlefield surveillance; today such networks are used in many industrial and consumer applications, such as industrial process monitoring and control, health monitoring instruments, and so on.

The Wireless mesh Environmental home Sensors Network is built of “nodes”—from a few to several hundreds or even thousands, where each node is connected to one (or sometimes several) sensors. Each such sensors network node has typically several parts: a radio transceiver with an internal antenna or connection to an external antenna, a microcontroller, an electronic circuit for interfacing with the sensors and an energy source, usually a battery or an embedded form of energy harvesting. A sensor node might vary in size from that of a shoebox down to the size of a grain of dust, although functioning “motes” of genuine microscopic dimensions have yet to be created. The cost of sensors nodes is similarly variable, ranging from a few to hundreds of dollars, depending on the complexity of the individual sensors' nodes. Size and cost constraints on sensors' nodes result in corresponding constraints on resources such as energy, memory, computational speed and communications band width. The topology of the Wireless mesh Environmental home Sensors Network, can vary from a simple star network to an advanced multi-hop Wireless mesh network. The propagation technique between the hops of the network can be routing or flooding.

The problems with the existing old technologies are:

Energy Problems:
1. Since most of home's sensors, as fire, smoke are battery powered, only sensors that consume a very low power are suitable to home use. Sensors that need higher power sources are not used in houses but only in industrial place.
2. Since home's sensors are eventually drain out the battery, thus the sensors are not working for long period of time.
3. Battery powered can't support Wi-Fi network or any other Wireless mesh network due the constant consumption of power from the battery.
4. Sensors can't hook to old legacy lamps sockets because when the lamps are switched off from the mains. the sensors still need to be powered all the time without relying on the state of the lamp as on or off
5. Digging a new canal is walls to transfer power to new home sensors are too expensive
6. Connecting high emergency sensors to mains (220V/110V) need certified technician.

Heat Problem:

Old tungsten lamps, are producing extensive heat. The temperature near the lamp is more than 120 Celsius degrees. Most sensors or Wireless mesh chipset can't survive in these conditions.

RF Radiation Problems

Old mesh networks as Wi-Fi network or Bluetooth network are working and transmitting all the time. This transmission produces RF radiation in the house and makes the habitat a dangerous place to live in. The idea of green environment and being flooded by RF is not acceptable.

In house habitat, most sensors, as fire, smoke, gas etc are battery powered. They hang on the ceiling and need a battery replacement from time to time. When hazardous condition is detected, normally an audio alert is sound. The alert can be sound in the range of the inner buzzer power, and since it is powered by battery the distance is very limited.

Due to the battery powered, there is no possibility for Wireless mesh transmitting the information to other node, since Wireless mesh transmission as Wi-Fi needs a large source of power. To send a power from the mains to the sensors need to dig a canal in the walls and ceiling that impose high cost.

Another problem is the fact that battery powered device can't Wireless mesh other node sensors since mesh Wireless mesh devices must be active all the time and they can't be powered by small battery. It need high power.

### SUMMARY OF THE INVENTION

The presented invention solves all the above problems,
Energy problems solved by embedded the sensors inside the led lamp, as the mains (220V/110v) powering the power to the lamp never closed. All kind of sensors can be used. The led lamp produces 5% heat in compare to tungsten lamp, so there is no heat problem. The power is present all the time, for mesh messages over Wireless mesh RF long range. And there is no radiation problem since the led lamp+sensor is on “listening mode, Observer mode” all the time without sending any RF radiating outside, until sensors events happened. An event can be sensor alarm or incoming RF message from other lamp to be mesh to house internet Wi-Fi router or to user phone/ipad/bridge.

In light of the aforementioned problems associated with the prior devices and systems, it is an object of the present invention to provide a Combination of Led Lamp and Wireless mesh Sensors Network in one case, and a related Method for creating a Local Sensors mesh Network. The device should be a combination of lighting Led Lamp and Sensors mesh network node. The combination of Led Lamp+Sensors assembly should be available both as original equipment, and as a retrofit kit for legacy Led Lamps. The Led Lamp portion of the combination of Led Lamp+Sensors should provide an area of lighting through a lens located in the housing within which the combination of Led Lamp+Sensors is housed. The node portion of the assembly should provide sophisticated sensors mesh network functionality such that the placement of series of devices of the present invention should provide a high quality, Wireless mesh that “mesh” the sensors data over RF network. The Led Lamp+sensors assembly should optionally provide local environmental and green habitat with safety functionality, including sensors in order to enable typical environmental and green habitat system functionality. The sensors mesh network created by inter connection of a series of the Led Lamp+sensors assemblies should include the ability to repair mesh messaging in the event of damage to one or more networked Led Lamp+sensors assemblies, as well as the ability to constantly seek to optimize electronic traffic through the local mesh network. The Led Lamp+Sensors assemblies may further include Infrared communications capabilities to facilitate sensors mesh communications between nodes in the sensors mesh by either Wi-Fi or Infrared means or to output Infrared communications to activate external devices.

Since legacy lamp network usually has a wall power switch that cuts the power to the lamp, normal lamp can't integrated with sensors that need power all the time. The present invention solves this power problem by embedded a Wireless mesh switch inside the lamp itself by doing that the lamp is been powered all the time, so the sensors are getting power all the time and since high power is power in, the sensors can use this power and the lamp controller has power to strong transmission signal to mesh for other nodes in the mesh network. The lamp is switched on or off by Wireless mesh wall switch

### DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1: This is the internal part of invented led lamp+sensors.

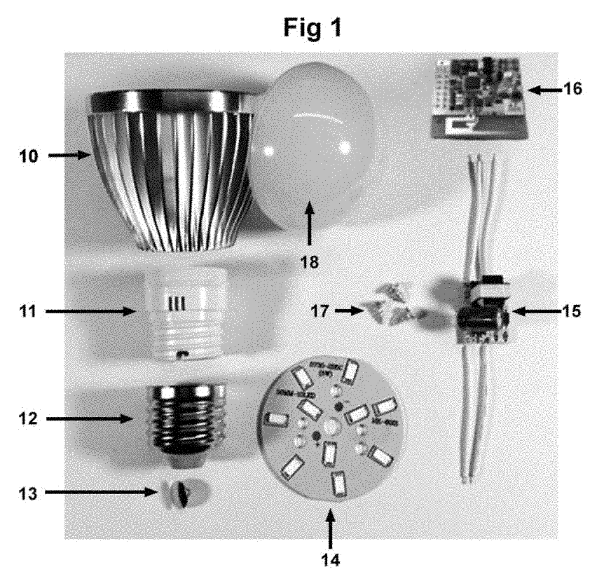

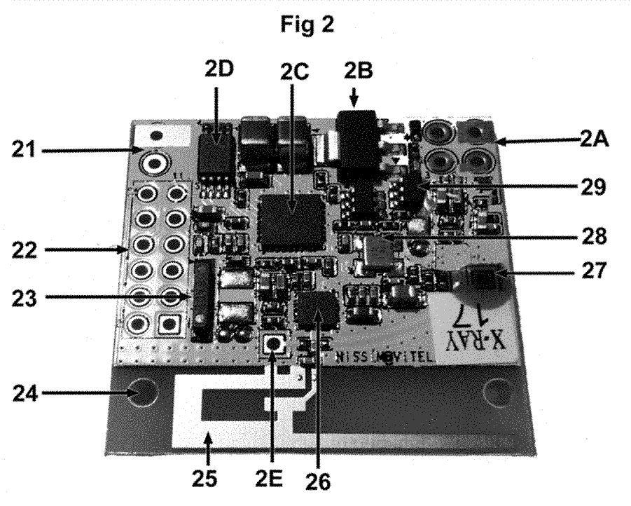

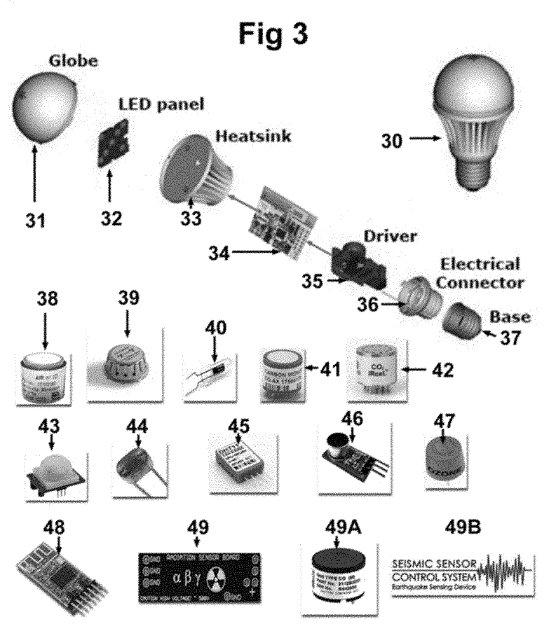

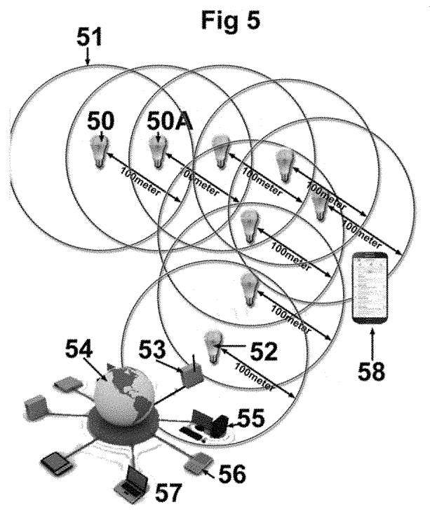

Item 10 led lamp lens holder. Item 11 is plastic connector. Item 12 is one side of the mains power source, item 13 is the other side of the power source. Item 18 is the lens, item 15 is the leds PCB. Item 15 is power supply to led PCB and to the controller PCB. Item 17 are lamp's screws. Item 16 is the controller PCB.

This lamp led has uniqueness on the added of item 16 that gets power from the power supply all the time. This lamp gets power all the time (220V or 110V) and item 16, the controller.

Item 15 gets 220V/110V AC and product DC from 9V to 60V as needed by the leds PCBs.

Item 16 has CPU with flash, Wireless mesh capabilities, switches capabilities of power to led PCB, and connection to sensors.

FIG. 2: This is the internal part of led lamp+sensors controller.

Item 21 is power DC input.

Item 22 is the connection to digital and analog sensors.

Item 23 is crystals to make the devices CPU able to use complex commands to sensors that control over I2C/SPI/UART

Item 2E is a hole to enable wire antenna for longer range

Item 25 is PCB antenna

Item 26 is RF power amplifier to extend the Wireless mesh transmission range

Item 27 and Item 2E are holes in PCB for wipe antenna

Item 2D is the controller flash memory, where the code of the CPU is stored.

Item 2C is the main CPU

Item 2B is the power source to reduce voltage for the leds DC level to CPU DC level

Item 28 is CPU main crystals

Item 2A is connection to led PCB. The DC power feeds the led PCB

Item 29 is the Mosfat electronic switch led current that switch it on or off

FIG. 3: This is the internal part of the invented of Led lamp+Sensors

Item 30 the look of Led lamp+Sensors. Other sensors are possible.

Item 30 lamp lens dome, plastic or glass

Item 32 the leds PCB

Item 33 led heat sink and lamp body. Metal or plastic

Item 34 the controller PCB

Item 35 220V/110 AC to DC to power the lamp+sensors.

Item 36 lamp plastic part

Item 37 the lamp two sides feed of mains

Item 38 possible sensors: Air quality detector.

Item 39 possible sensors: Flammable gas detector

Item 40 possible sensors: IR Fire detector, and IR transmitter to activate home devices work on IR remote control

Item 41 possible sensors: Carbon monoxide detector

Item 42 possible sensors: CO2 detector

Item 43 possible sensors: IR human moving alarm sensors

Item 44 possible sensors: light sensor

Item 45 possible sensors: humidity and temperature sensors

Item 46 possible sensors: Audio noise sensor

Item 47 possible sensors: Ozone sensor

Item 48 possible sensors: Wi-Fi and proximity for smart phone sensors, and bridges to other Wireless mesh technologies

Item 49 possible sensors: Radiation sensors

Item 49A possible sensors: Home gas detector

Item 49B possible sensors: Seismic sensor

The invention is not limited to this sensors, other sensors may be connected too.

FIG. 5: This is the led lamp+Sensor mesh over area

Item 50 is the Led lamp +Sensor, the inside controller transmits up to some distance, for example 100 meter. This range is used to create dynamic mesh sensors and lamp to the next led lamp+sensors.

Item 51 is the covered range. Every led lamp+sensor is working as “Observer” it does not transmit out any RF information. Once one of its sensors activated, it changes its profile to “Broadcaster” and sends the info out, and return to its Observer mode. This switching is happened also when the led lamp+sensor gets RF input information from other Led lamp+Sensor, and then it bridges it forward. Some cover RF areas as item 51 can cover several led lamp+sensor for redundancy. Every Led lamp+Sensor can use the input of other sensors in the mesh to report more hazardous condition as fire, smoke etc. The control in the lamp can switched on/off the light of the led lamp+sensor to alert the nearby humans,

Item 50A is example of Led lamp+Sensor that get RF alert over Led lamp+Sensor 50 and bridge that on.

Item 58 is smart phone that become part of Led lamp+Sensor to be configuring the Led lamp+Sensor over the mesh and alerted the user carry the phone and using the phone/tablet/PC to send to the internet that alert or any home wireless bridge to do the same, as Wi-Fi Bluetooth Smart. The led part of the lamp can also blink to get the attention of the user around it, and auto send command to other lamp in the mesh network to do the same blinking.

Item 52 is example of Led lamp+Sensor that is near a Led lamp+Sensor Wi-Fi internet bridge (item 53) that sends the alert message to internet or gets configuration setting to the led lamp+sensor network.

Item 53 Led lamp+Sensor Wi-Fi internet bridge (item 53) that sends all Led lamp+Sensor mesh messages to internet or/and to use Smart phone devices.

Item 54 internet cloud

Item 56 user carry devices as smart phone, tablets etc that can get led lamp+sensor messages or send commands.

Item 57 user PC devices as laptop that can get Led lamp+Sensors messages or send commands.

We claim:

1. a wireless lamp (A combination Led lamp+Sensors and Wireless mesh Network) that comprises:
a led lamp housing,
a Led lamp inner power supply,
one environmental sensor or more additional sensors for sensing additional environmental sensors,
a processor that is attached to sensors,
a processor that controls the LED's power by an electronic switch from led lamp inner power supply,
a processor's power supply that feeds from the led lamp inner power supply,
a processor flashes that used to store sensors thresholds levels
a short range wireless transceiver circuit,
a long range wireless transceiver circuit,
wherein the wireless transceiver circuit connect to internet,
wherein the wireless transceiver is used to send to the processor sensors thresholds levels,
wherein the processor uses wireless transceiver on detection bridging the sensors thresholds levels,
wherein the wireless transceiver circuit creates a mesh network nodes with other a wireless lamp,
wherein the wireless transceiver circuit creates a mesh network nodes with other wireless devices,
wherein the wireless transceiver mesh network nodes is on Observer mode, no RF our
wherein the wireless transceiver mesh network nodes is swicth to Broadcast mode, RF out, only on sensing sensors thresholds event or RF in need to mesh RF out,
wherein the power to led lamp remain on all the time and switching led off is done by wireless command,
wherein Wireless mesh sensors Network subsystem is a PCB; and
Wireless mesh sensors Network subsystem PCB located between the led lamp internal power supply and the leds front panel;

2. The wireless lamp according to claim 1 wherein at least a majority of a transmission of the wireless transceiver circuit are the alerts

3. The wireless lamp according to claim 1 wherein an environmental sensor can be read from external wireless source.

4. The wireless lamp according to claim 1 wherein further comprises an infrared communications subsystem within said housing.

5. The wireless lamp according to claim 1 wherein further comprises an infrared communications that can send Infra-Red commands based on wireless command.

6. The wireless lamp according to claim 1 wherein Wireless mesh node can create lamp groups.

7. The wireless lamp according to claim 1 further comprising a wide area sensors network communications conduit in connection with said node.

8. The wireless lamp according to claim 1 wherein Wireless mesh node is used to bridge any Bluetooth Smart device and wireless information to the internet.

9. The wireless lamp according to claim 1 wherein the electric power swicth is use to blink the leds lamp light based on sensor event

10. The wireless lamp according to claim 1 wherein Wireless mesh utilizes an electric power swicth within every node to blink the leds lamp lights based on any sensor's event on any mesh network node.

11. The wireless lamp according to claim 1 can sense Wi-Fi and proximity to smart phone.

12. A method for the wireless lamp, the method comprises:
a led lamp housing,
a Led lamp inner power supply,
one environmental sensor or more additional sensors for sensing additional environmental sensors,
a processor that is attached to sensors,
a processor that controls the LED's power by an electronic switch from led lamp inner power supply,
a processor's power supply that feeds from the led lamp inner power supply,
a processor flashes that used to store sensors thresholds levels
a short range wireless transceiver circuit,
a long range wireless transceiver circuit,
wherein the wireless transceiver circuit connect to internet,
wherein the wireless transceiver is used to send to the processor sensors thresholds levels,
wherein the processor uses wireless transceiver on detection bridging the sensors thresholds levels,
wherein the wireless transceiver circuit creates a mesh network nodes with other a wireless lamp,
wherein the wireless transceiver circuit creates a mesh network nodes with other wireless devices,
wherein the wireless transceiver mesh network nodes is on Observer mode, no RF our
wherein the wireless transceiver mesh network nodes is swicth to Broadcast mode, RF out, only on sensing sensors thresholds event or RF in need to mesh RF out,
wherein the power to led lamp remain on all the time and switching led off is done by wireless command,
wherein Wireless mesh sensors Network subsystem is a PCB; and
Wireless mesh sensors Network subsystem PCB located between the led lamp internal power supply and the leds front panel;

13. The method according to claim 12 wherein at least a majority of transmissions of the wireless transceiver circuit are the alerts

14. The method according to claim 12 wherein an environmental sensor can be read from external wireless source.

15. The method according to claim 12 wherein an infrared communications subsystem within said housing.

16. The method according within The wireless lamp according to claim 12 the infrared communications that can send Infra-Red commands based on wireless command.

17. The method according to claim 12 wherein Wireless mesh node can create lamp groups.

18. The method according to claim 12 further comprising a wide area sensors network communications conduit in connection with said node.

19. The method according to claim 12 wherein Wireless mesh node is used to bridge any wireless device information to the internet.

20. The method according to claim 12 wherein the electric power swicth is used to blink the leds lamp light based on sensor's event

21. The method according to claim 12 wherein Wireless mesh utilizes an electric power switches within every node to blink the local leds lamp light based on any sensor's event on other nodes.

22. The method according to claim 12 can sense Wi-Fi and proximity to smart phone.

23. The method according to claim 12 can get a wireless command to swicth on/off/dim the leds in led lamp
